(19) United States
(12) Patent Application Publication
(10) Pub. No.: US 2015/0002885 A1
(43) Pub. Date: Jan. 1, 2015

(54) IMAGE FORMING APPARATUS AND IMAGE FORMING METHOD

(71) Applicant: KYOCERA Document Solutions Inc., Osaka (JP)

(72) Inventor: Kazuhiro TAKAHASHI, Osaka (JP)

(73) Assignee: KYOCERA Document Solutions Inc., Osaka (JP)

(21) Appl. No.: 14/318,612

(22) Filed: Jun. 28, 2014

(30) Foreign Application Priority Data
Jun. 28, 2013 (JP) 2013-136621
Jun. 20, 2014 (JP) 2014-127023

(51) Int. Cl. G06K 15/00

(52) U.S. Cl. CPC G06K 15/4055
USPC 358/1.14

(57) ABSTRACT

Allowing a counter electromotive force to be consumed with no need for adding a circuit for detecting a counter electromotive force and a component, and minimizing occurrence of malfunction resulting from generation of a counter electromotive force, thus securing the normal interlock function. In order to solve this problem, a motor unit, a power cut-off detection part for detecting whether or not supply of power from a power supply is cut off, and a switch mechanism for switching between driving and non-driving of the motor unit. Further, when the power cut-off detection part has detected cut-off of supply of power from the power supply, driving of respective mechanisms provided for an image forming apparatus are stopped. Further, a control part is provided which uses a second switch mechanism for causing the motor unit and the fan motor to be connected.

### INCORPORATION BY REFERENCE

This application is based on and claims the benefit of priority from Japanese Patent Application No. 2013-136621 filed on Jun. 28, 2013 and Japanese Patent Application No. 2014-127023 filed on Jun. 20, 2014, and the contents of which are hereby incorporated by reference.

### BACKGROUND

The present disclosure relates to an image forming apparatus and an image forming method, and particularly to a technology for controlling respective mechanisms provided for the image forming apparatus in response to opening and closing of a main body cover provided for the apparatus main body.

With the image forming apparatus, conveyance rollers carry a recording sheet with a driving force supplied thereto from a motor, and an image forming part forms an image on the recording sheet which has been carried in. In such image forming apparatus, in the case where the recording sheet has clogged at a carrying passage, in other words, there has occurred a jam, an operator opens a main body cover to expose an internal mechanism a removes the recording sheet clogging the carrying passage. At this time, with the main body cover being opened, an interlock switch is turned off, supply of power to the motor being cut off, and a power cut-off detection circuit detects the power cut-off to output it to a CPU, thereby operation of the respective mechanisms of the image forming apparatus being stopped.

Further, recently, as a mechanism for transmitting a driving force from the aforementioned motor to the conveyance rollers in the image forming apparatus, a mechanism which uses a one-way clutch in place of a two-way clutch, or which is provided with no clutch may be adopted from the viewpoint of cost reduction. In this case, at the time of the aforementioned jam clearing, when the operator pulls out the recording sheet clogging the carrying passage therefrom, resulting in the conveyance rollers catching the recording sheet being rotated, thereby the motor being rotated, the motor may function as a generator to thereby generate a counter electromotive force. In this way, when a voltage is generated by a counter electromotive force occurring in the motor at the time of jam clearing, the aforementioned power cut-off circuit erroneously detects that power is supplied, in other words, that the main body cover has been closed, and on the basis of this detection result, the control part makes such a malfunction as causing the respective mechanisms of the image forming apparatus to resume the normal operation.

Accordingly, there is a technique which provides a counter electromotive voltage detection circuit for detecting the aforementioned counter electromotive force. When a counter electromotive voltage having been detected by the circuit, a motor is driven with the counter electromotive force, thereby consuming the counter electromotive force. Further, there is a technique which adds a diode to the relevant circuit to thereby consume the aforementioned counter electromotive force. Further, there is a technique which provides a counter electromotive voltage detection circuit, and when it has been detected that the power supply voltage has been lowered to under a value at the time of normal operation, turns on a ground side output transistor, thereby applying a brake to the rotation of a motor for preventing the power supply voltage from being raised.

### SUMMARY

An image forming apparatus according to one aspect of the present disclosure includes a motor unit, an interlock switching circuit, a power cut-off detection part, a drive unit, a connection switching part, and a control part. The motor unit imparts a rotation driving force to respective rotating members for carrying a recording medium. The interlock switching circuit is provided in a power supply line for connecting a power supply to the motor unit to supply power thereto, connecting between the motor unit and the power supply upon a main body cover being closed, and disconnecting between the motor unit and the power supply upon the main body cover being opened. The power cut-off detection part detects whether or not supply of power from the power supply is cut off on the basis of a voltage of the power supply line. The drive unit is connected to the power supply and the motor unit by the power supply line, imparting a rotation driving force to a mechanism provided as a driven body, the mechanism being different from the respective rotating members. The connection switching part switches over to connection or disconnection between the motor unit and the drive unit. Upon cut-off of supply of power from the power supply being detected by the power cut-off detection part, the control part stops driving of respective mechanisms provided, and causes the connection switching part to connect between the motor unit and the drive unit.

An image forming method according to one aspect of the present disclosure is an image forming method which is implemented by an image forming apparatus including a motor unit, an interlock switching circuit, a power cut-off detection part, and a drive unit. The motor unit imparts a rotation driving force to respective rotating members for carrying a recording medium. The interlock switching circuit is provided in a power supply line for connecting a power supply to the motor unit to supply power thereto, connecting between the motor unit and the power supply upon a main body cover being closed, and disconnecting between the motor unit and the power supply upon the main body cover being opened. The power cut-off detection part detects, on the basis of a voltage of the power supply line, whether or not supply of power from the power supply is cut off. The drive unit is connected to the power supply and the motor unit by the power supply line, imparting a rotation driving force to a mechanism provided as a driven body, the mechanism being different from the respective rotating members. With the method of the present disclosure, upon cut-off of supply of power from the power supply having been detected, driving of respective mechanisms is stopped, and the motor unit is connected to the drive unit.

### BRIEF DESCRIPTION OF THE DRAWINGS

FIG. 1 is a front sectional view showing a structure of an image forming apparatus according to one embodiment of the present disclosure;

FIG. 2 is a functional block diagram illustrating a main internal configuration of the image forming apparatus;

FIG. 3 is a diagram showing the configuration of an interlock mechanism provided for the image forming apparatus;

FIG. 4 is a diagram showing the voltage of the power supply line with a graph in the case where the drive motor is rotated in a reverse direction with the switching circuit being in an open state; and

FIG. 5 is a flowchart illustrating the flow of processing at the time of operation control of the image forming apparatus according to the voltage of the power supply line.

### DETAILED DESCRIPTION

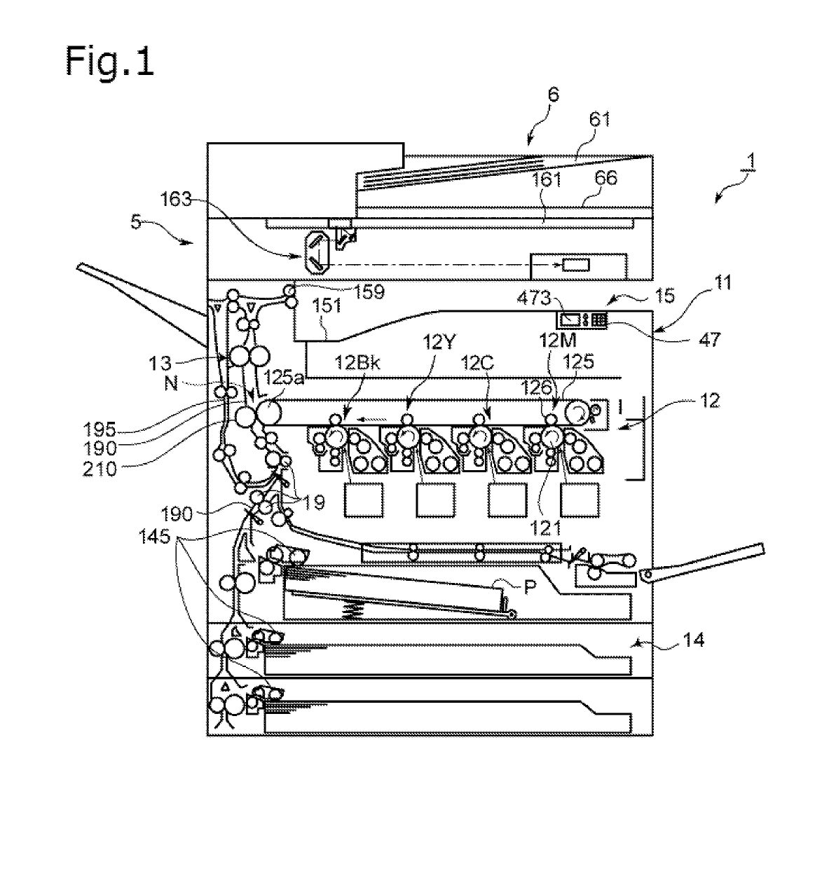

Hereinbelow, an image forming apparatus according to one embodiment of the present disclosure will be explained with reference to the drawings. FIG. 1 is a front sectional view showing the structure of the image forming apparatus according to one embodiment of the present disclosure.

An image forming apparatus 1 according to one embodiment of the present disclosure is, for example, a multifunctional peripheral provided with a plurality of functions, such as a copying function, a printer function, a scanner function, and a facsimile function. The image forming apparatus 1 is configured to include an operation part 47, an image forming part 12, a fixing part 13, a paper feeding part 14, a document feeding part 6, and a document reading part 5, and the like, in an apparatus main body 11.

The operation part 47 receives instructions from an operator for various operations and processings which can be executed by the image forming apparatus 1, such as an instruction for executing an image forming operation and an instruction for executing a document reading operation. The operation part 47 includes a display part 473 which displays an operation guide for use by the operator, an image for reporting occurrence of a jam, or the like.

In the case where the image forming apparatus 1 performs a document reading operation, the document reading part 5 optically reads an image of a document fed by the document feeding part 6, or a document placed on a document mounting glass 161 to generate image data. The image data generated by the document reading part 5 is stored in a built-in HDD, a computer connected to the network, or the like.

In the case where the image forming apparatus 1 performs an image forming operation, the image forming part 12 forms a toner image on a recording sheet P as a recording medium fed by the paper feeding part 14 on the basis of image data generated by the aforementioned document reading operation, image data received from the computer connected to the network, image data stored in the built-in HDD, or the like. In the case where the image forming apparatus 1 performs color printing, an image forming part 12M for magenta, an image forming part 12C for cyan, an image forming part 12Y for yellow, and an image forming part 12Bk for black of the image forming part 12 form a toner image on a photosensitive drum 121 through the processes of charge, exposure, and development, respectively, on the basis of an image comprised of respective color components constituting the aforementioned image data, and transfer the toner image onto an intermediate transfer belt 125 by a primary transfer roller 126.

Each of the image forming part 12M, the image forming part 12C, the image forming part 12Y, and the image forming part 12Bk includes a polygon motor which drives a polygon mirror for reflecting light to form a toner image on the photosensitive drum 121. The polygon motor is one example of the drive unit.

The toner images of the aforementioned respective colors that are transferred onto the intermediate transfer belt 125 are superposed one upon another on the intermediate transfer belt 125 with the transfer timing being adjusted, thereby a color toner image being produced. A secondary transfer roller 210 transfers the color toner image formed on the surface of the intermediate transfer belt 125 onto a recording sheet P carried along a carrying passage 190 from the paper feeding part 14 by a conveyance roller pair (one example of the rotating member) 19 in a nip part N formed between the intermediate transfer belt 125 and the drive roller 125a. Thereafter, the fixing part 13 fixes the toner image provided on the recording sheet P onto the recording sheet P by thermocompression bonding. The recording sheet P with which the fixing processing has been completed, a color image having been formed thereon, is delivered to a delivery tray 151.

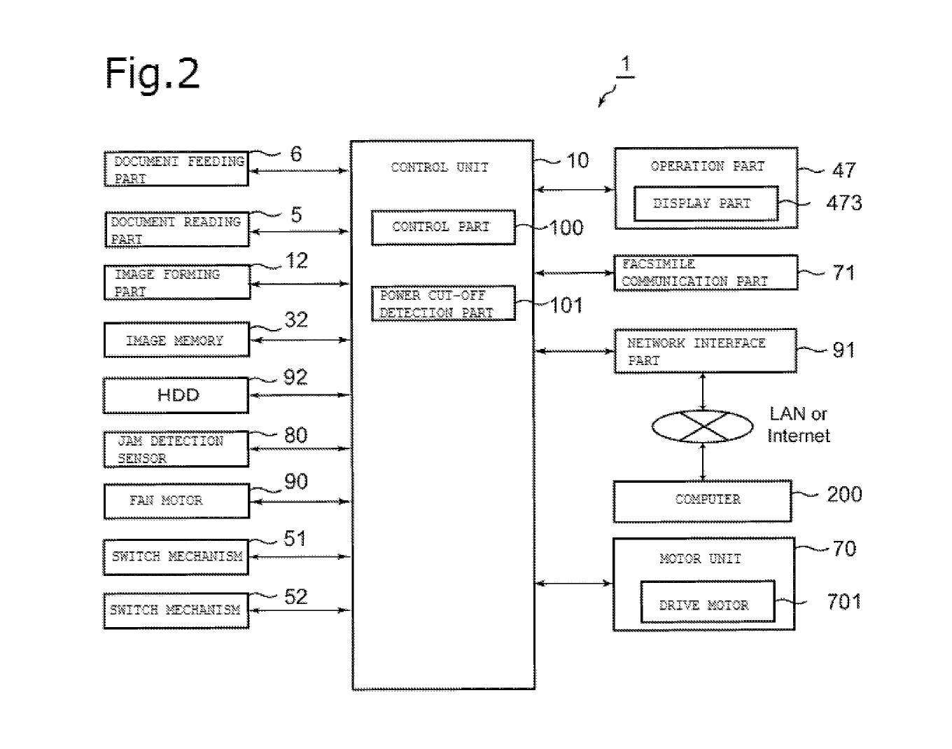

The paper feeding part 14 includes a plurality of paper feeding cassettes. The control part 100 (FIG. 2) rotation-drives pickup rollers 145 (one example of the rotating member) for a paper feeding cassette containing recording sheets of a size specified by the operator's instruction and carries a recording sheet P contained in the paper feeding cassette toward the aforementioned nip part N.

In addition, in the case where the image forming apparatus 1 performs both-side printing, the recording sheet P with which an image is formed on one surface thereof by the image forming part 12 is brought into a state in which it is nipped between the delivery roller pair 159. Thereafter, the recording sheet P is switched back by the delivery roller pair 159 to be fed to an inverting carrying passage 195. Then, the recording sheet P is again carried by the conveyance roller pair 19 to a zone located upstream of the aforementioned nip part N and fixing part 13 in the direction of carrying the recording sheet P. Thereby, the image forming part 12 forms the image on the other surface of the recording sheet.

On the front, sides, and the like, of the image forming apparatus 1, there is disposed a main body cover (not shown) which can be opened and closed. The opening or closing of the main body cover is interlocked with the on-off operation of a switching circuit 58 which switches between supply and non-supply of power from a later described power supply 60 to a motor unit 70. The control part 100 normally operates the respective mechanisms of the image forming apparatus 1 when power is supplied from a power supply 60 to a motor unit 70 with the switching circuit 58, which becomes turned on state in a case of closing the main body cover.

In the case where a jam having occurred in the inside of the image forming apparatus 1 is to be cleared, or a toner cartridge is to be replaced, the operator opens the aforementioned main body cover to expose the recording sheet jam portion or the toner cartridge. In that case, when the power supplied from the power supply 60 to the motor unit 70 is cut off with the switching circuit 58, which becomes turned off state in case of opening the main body cover, the control part 100 stopping the operation of the respective mechanisms of the image forming apparatus 1. In other words, with the image forming apparatus 1, the interlock function is activated in the state where the main body cover is opened.

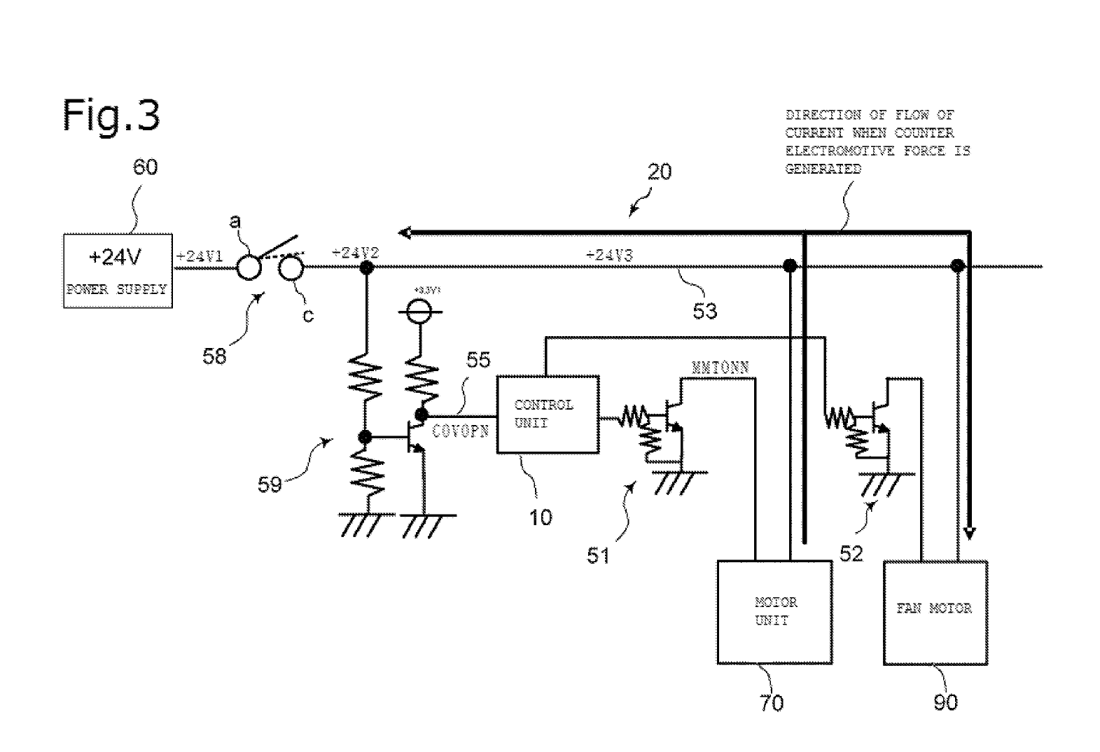

Next, the main internal configuration of the image forming apparatus 1 will be explained. FIG. 2 is a functional block diagram illustrating the main internal configuration of the image forming apparatus 1. FIG. 3 is a figure showing a configuration of an interlock mechanism provided for the image forming apparatus 1.

The image forming apparatus 1 includes a control unit 10, the operation part 47, the document feeding part 6, the document reading part 5, an image memory 32, the image forming part 12, the motor unit 70, a facsimile communication part 71, a network interface part 91, a jam detection sensor 80, and an HDD 92, and the like.

The document reading part 5 includes a reading mechanism 163 (FIG. 1) having a light irradiation part, and a CCD sensor, and the like, which are under the control of the control unit 10. The document reading part 5 uses the light irradiation part to irradiate a document with light, and receives the reflected light by the CCD sensor to thereby read the document color image.

The image memory 32 provides an area for temporarily storing the data of a document image read by the document reading part 5, or temporarily saving data for use as a printing object of the image forming part 12.

The facsimile communication part 71 includes an encoding/decoding part (not shown), a modulation/demodulation part (not shown), and an NCU (Network Control Unit) (not shown) for performing facsimile transmission using a public telephone network.

The network interface part 91 is comprised of a communication module, performing transmission/reception of various data to/from a computer 200, and the like, on the network connected to the network interface part 91.

The HDD 92 is a large-capacity storage device for storing a document image, and the like, read by the document reading part 5.

The motor unit 70 includes a drive motor 701, and a driving circuit (driver) for driving the drive motor 701. The drive motor 701 is a driving source for imparting a rotation driving force to the conveyance roller pair 19, and the respective other rotating members in the image forming part 12, and the like. The rotation driving force of the drive motor 701 is transmitted to the respective rotating members through gears (not shown). In the present embodiment, as a mechanism for transmitting a driving force from the drive motor 701 to the aforementioned respective rotating members, a mechanism which uses a one-way clutch, or which is provided with no clutch is adopted.

The jam detection sensor 80 is a sensor which detects a recording sheet jam on the passage, such as the carrying passage 190, along which the recording sheet P is carried, and outputs a detection signal indicating the existence of a jam to the control unit 10. The jam detection sensor 80 is provided in appropriate places in the carrying passage 190 for carrying the recording sheet P.

The fan motor 90 is a motor for supplying a rotation driving force to a fan for cooling the internal mechanism of the image forming apparatus 1. The fan motor 90 is one example of the drive unit. The fan motor 90 need not always be rotated if a voltage is applied thereto, or may function as a resistance which consumes power.

The switch mechanism 51 is comprised of, for example, a transistor, and the like, being a switch provided between the control part 100 and the motor unit 70. The switch mechanism 51 switches between driving and non-driving of the motor unit 70 in accordance with a remote signal outputted from the control part 100.

The switch mechanism 52 (one example of the connection switching part) is comprised of, for example, a transistor, and the like, being a switch provided between the control part 100 and the fan motor 90. The switch mechanism 52 switches between driving and non-driving of the fan motor 90 in accordance with a remote signal outputted from the control part 100.

The control unit 10 is comprised of a CPU, an RAM, an ROM, a specialized hardware circuit, and the like, controlling the entire operation control of the image forming apparatus 1. The control unit 10 includes the control part 100 and a power cut-off detection part 101.

The control part 100 is connected to the operation part 47, the document feeding part 6, the document reading part 5, the image memory 32, the image forming part 12, the motor unit 70, the fan motor 90, the facsimile communication part 71, the network interface part 91, and the HDD 92, and the like, controlling these respective components.

The control part 100 receives a jam detection signal outputted from the jam detection sensor 80, and it performs processes, such as stopping the driving of the drive motor 701 for interrupting the carrying of the recording sheet P. In addition, the control part 100 outputs a remote signal to the switch mechanisms 51 and 52 to thereby control the driving or non-driving of the motor unit 70 and the fan motor 90. Further, the control part 100 switches over to connection or disconnection between the motor unit 70 and the fan motor 90 (the details will be described later).

The power cut-off detection part 101 detects whether or not supply of power from the power supply 60 (FIG. 3) to the motor unit 70 is cut off. The power cut-off detection part 101 detects whether supply of power is performed or cut off on the basis of, for example, a voltage generated in a power supply line 53 which connects between the power supply 60 and the motor unit 70. On the basis of the detection result by the power cut-off detection part 101, the control part 100 performs control of the driving or the driving stop of the respective mechanisms of the image forming apparatus 1. For example, when the power cut-off detection part 101 has detected cut-off of supply of power from the power supply 60, the control part 100 will stop the driving of the respective mechanisms provided for the image forming apparatus 1, and controls the aforementioned switch mechanism 52 to connect the motor unit 70 to the fan motor (the details will be described later).

Further, the power cut-off detection part 101 detects whether or not the voltage generated in the power supply line 53 has been raised. In other words, the power cut-off detection part 101 detects a rise in voltage of the power supply line 53 resulting from power being supplied from the power supply 60 to the power supply line 53 or a counter electromotive force being supplied to the power supply line 53.

The image forming apparatus 1 includes an interlock mechanism 20 as shown in FIG. 3. The interlock mechanism 20 switches between supply of power and stop of supply of power to the motor unit 70. The interlock mechanism 20 includes a switching circuit 58, the motor unit 70, and the fan motor 90.

The switching circuit 58 is an interlock switching circuit which is operated in interlock with the opening and closing of the main body cover of the image forming apparatus 1. When the main body cover is closed, the switching circuit 58 causes the contact “a” to be contacted with the contact “c” as shown with a dotted line in FIG. 3 for connecting the power supply 60 with the power supply line 53. When the operator opens the main body cover of the image forming apparatus 1, the switching circuit 58 brings the contact “a” and the contact “c” into a non-contact state as shown with a solid line in FIG. 3.

The power supply 60 is a source of supply of power to the motor unit 70, being a +24-V power supply in the present embodiment. Between the power supply 60 and the motor unit 70, and between the power supply 60 and the fan motor 90 are connected by means of a power supply line 53, the aforementioned switching circuit 58 being provided therein.

Further, to the power supply line 53 connecting between the power supply 60 and the motor unit 70, there is connected a connection line 55 for inputting a voltage of the power supply line 53 to the control part 100. For the connection line 55, a voltage dividing circuit 59 is provided to transform the voltage of the +24-V power supply 60 to a level at which the voltage can be inputted to a port of the control unit 10 comprised of a CPU, and the like.

To the port of the control unit 10, the voltage after having been transformed by the voltage dividing circuit 59 is inputted.

The switch mechanism 51 receives a remote signal from the control part 100, and switches over to connection or disconnection between the motor unit 70 and the power supply 60.

The switch mechanism 52 receives a remote signal from the control part 100, and switches over to connection or disconnection between the fan motor 90 and the power supply 60.

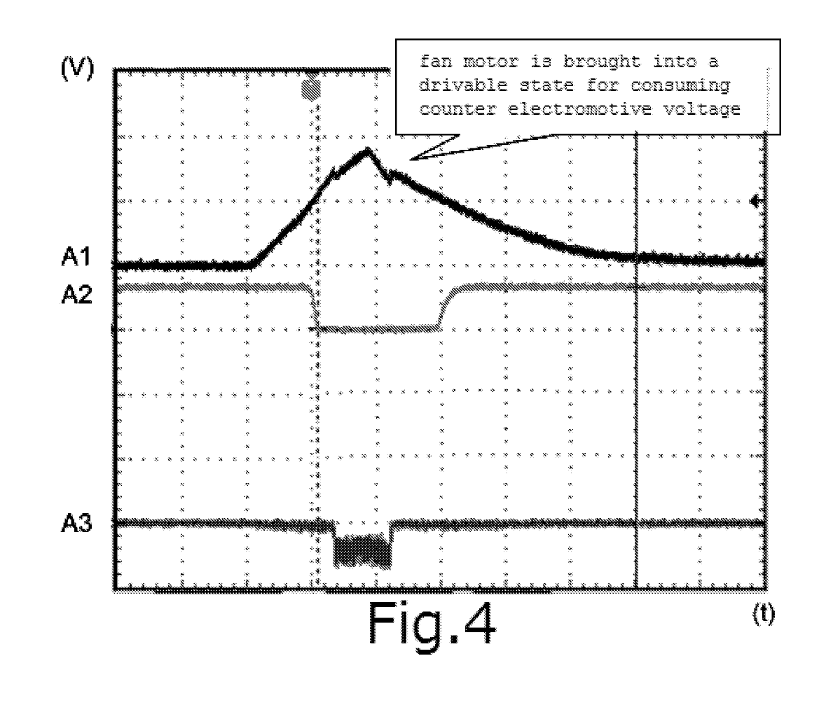

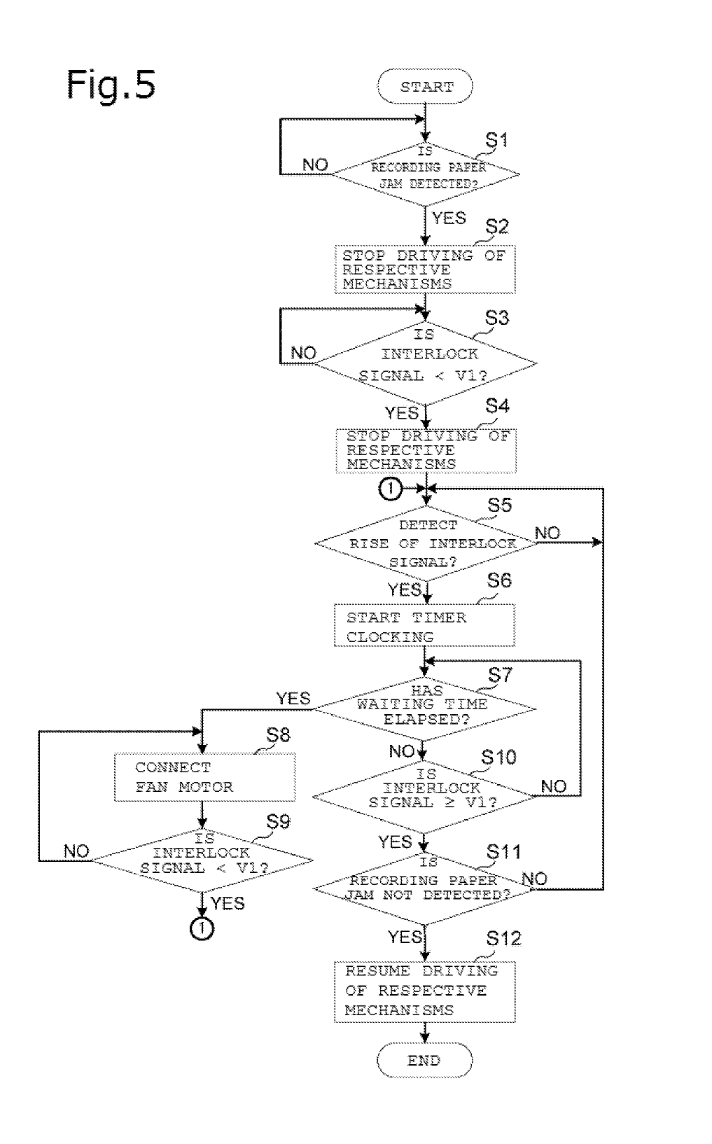

Next, the operation control of the image forming apparatus 1 according to the voltage of the power supply line 53 will be explained with reference to FIG. 4 and FIG. 5 in addition to the aforementioned FIG. 3. FIG. 4 is a diagram showing the voltage of the power supply line 53 with a graph in the case where the drive motor 701 is rotated in a reverse direction with the switching circuit 58 being opened. FIG. 5 is a flowchart illustrating the flow of processing at the time of operation control of the image forming apparatus 1 according to the voltage of the power supply line 53.

At the time of the image forming apparatus 1 being operated to perform, for example, image forming, if a recording sheet jam is detected by the jam detection sensor 80 (YES in S1), the control part 100 stops the driving of the respective mechanisms of the image forming part 12, and the like, of the image forming apparatus 1 (S2). At this time, the control part 100 sends a remote signal to the switch mechanism 51, and the switch mechanism 51 becomes turned off state. Thus, the motor unit 70 is switched over to a non-driving state. Further, the control part 100 sends a remote signal to the switch mechanism 52, and the switch mechanism 52 becomes turned off state. Thus, the fan motor 90 is switched over to a non-driving state.

Then, when the operator opens the main body cover of the image forming apparatus 1 to clear the recording sheet jam, the switching circuit 58 brings the contact “a” and the contact “c” into a non-contact state (which is shown with a solid line in FIG. 3). This brings a state in which the power from the power supply 60 will not be supplied to the motor unit 70 and the fan motor 90.

The power cut-off detection part 101 judges whether the voltage of the power supply line 53 that is inputted through the connection line 55 (hereinafter to be referred to as the interlock signal) has been lowered to under a predetermined threshold value, for example, a value V1 which is preset as a voltage value corresponding to that which would be given in the case where the power is supplied from the power supply 60 (for example, +24-V) (S3). In the case where the power cut-off detection part 101 has detected that the interlock signal has been lowered to under the voltage value V1 (YES in S3), the control part 100 again performs control for driving-stop of the respective mechanisms of the image forming apparatus 1, assuming that the main body cover of the image forming apparatus 1 is opened (S4). In this state, since the contact “a” and the contact “c” of the switching circuit 58 are in a non-contact state, the interlock signal is lowered down to a value close to 0 V. While the power cut-off detection part 101 does not detect that the interlock signal has been lowered to under the voltage value V1 (NO in S3), the program will not proceed to the step S4 and subsequent.

Thereafter, the power cut-off detection part 101 detects a rise in voltage of the power supply line 53 that is inputted through the connection line 55, and the control part 100 determines whether the power cut-off detection part 101 has detected this rise of the interlock signal (S5). In the case where the control part 100 has determined that the power cut-off detection part 101 has detected this rise of the interlock signal (YES in S5), the control part 100 starts clocking with a built-in timer, or the like, (S6), to determine whether or not a predetermined waiting time has elapsed (S7). This waiting time is set at a time longer than that (for example, 2 ms) which, when the main body cover is closed, resulting in the switching circuit 58 being closed, the interlock signal must take to reach the aforementioned voltage value V1, starting from the value thereof when the switching circuit 58 is opened, and shorter than that (for example, 300 ms) which is taken by the interlock signal to reach the aforementioned voltage value V1 when a later described counter electromotive force is generated.

Here, in the case where the control part 100 has determined that, before it is determined that the waiting time has elapsed (NO in S7), the power cut-off detection part 101 has detected that the interlock signal has reached the aforementioned voltage value V1 (YES in S10), the control part 100 drives the respective mechanisms of the image forming apparatus 1 to resume the operation (S12), if the aforementioned jam detection sensor 80 indicates that no recording sheet jam is detected (YES in S11).

On the other hand, in the case where the control part 100 has determined that the waiting time has elapsed without the interlock signal reaching the aforementioned voltage value V1 (NO in S10, and YES in S7), the control part 100 sends a remote signal to the switch mechanism 52, and switch mechanism 52 becomes turned on state. Thus, the motor unit 70 and the fan motor 90 is connected, and the fan motor 90 is switched over to a drivable state (S8). In this case, switch mechanism 51 keeps turned off state, and the switch mechanism 52 keeps turned on state during a predetermined time.

Thereafter, in the case where the power cut-off detection part 101 has detected that the interlock signal has been lowered to under the aforementioned preset value V1 (YES in S9), the switch mechanism 52 becomes turned off state, and then the program is returned to S5. Thereafter, the step of determining that a rise of the interlock signal has been detected and those following it are repeated.

In the case where the power cut-off detection part 101 has not detected that the interlock signal has been lowered to under the aforementioned preset value V1 (NO in S9), the state in which the motor unit 70 and the fan motor 90 are connected is maintained.

For example, when the main body cover is in an open state, the conveyance roller pair 19 or the image forming part 12 being exposed, the operator pulling out the recording sheet P caught in a nip part between the conveyance roller pair 19, a nip part between the drive roller 125a and the secondary transfer roller 210, or a nip part between the roller pair of the fixing part 13 for clearing the recording sheet jam may rotate any one of the aforementioned respective roller pairs, such as the conveyance roller pair 19, in a reverse direction, resulting in the drive motor 701 being rotated to operate as a generator, generating a counter electromotive force. If, as with the image forming apparatus 1, the mechanism for transmitting a driving force from the drive motor to the aforementioned respective rotating members, such as the conveyance roller pair 19, the roller pair of the fixing part 13, the drive roller 125a, and the secondary transfer roller 210, adopts a one-way clutch, or uses no clutch, the electromotive force is directed from the drive motor 701 toward the power supply, thereby a voltage attributable to the electromotive force being developed in the power supply line 53.

Conventionally, if there occurs a rise in voltage that is attributable to the aforementioned counter electromotive force, it has been erroneously detected as the main body cover having been closed, resulting in the control part starting running of the drive motor in a forward direction while it is rotated in a reverse direction with the recording sheet being pulled out as mentioned above, and thus there has been a possibility of occurrence of a trouble such as the motor driver for the drive motor being damaged due to its withstand voltage.

Also in the present embodiment, the counter electromotive force of the drive motor 701 raises the voltage A1 as the interlock signal as shown in FIG. 4, however, in the present embodiment, in the case where the power cut-off detection part 101 has determined that the interlock signal is not reached to the voltage value V1 and elapses the waiting time (YES in S7), the control part 100 causes the switch mechanism 52 to connect between the motor unit 70 and the fan motor 90 to bring the fan motor 90 into a drivable state (S8). As shown in FIG. 3, since the motor unit 70 and the fan motor 90 share the power supply line 53 from the power supply 60, after the step in S8, the motor unit 70 and the fan motor 90 are connected to each other, and the power of the counter electromotive force generated by the motor unit 70 is used to drive the fan motor 90, thereby, as shown with a voltage A3 in FIG. 4, the electric current in the power supply line 53 being consumed.

Therefore, as shown in FIG. 4, even if the voltage A1 as the interlock signal of the power supply line 53 has been once raised, the aforementioned power consumption of the fan motor 90 lowers the voltage, returning it to the voltage value of the interlock signal in an open state of the main body cover (a value close to 0 V). Thereby, according to the present embodiment, there will not occur such a malfunction as the control part 100 causing the respective mechanisms of the image forming apparatus 1 to resume the normal operation although the main body cover of the image forming apparatus 1 is not closed, and an event that the control part 100 causes the drive motor 701 to run in a forward direction while it is rotated in a reverse direction with the recording sheet P being pulled out, thereby such a trouble as the motor driver for the drive motor 701 being damaged will not be caused.

Thereby, in the present embodiment, in spite of generation of a counter electromotive force by the drive motor 701, the respective mechanisms of the image forming apparatus 1 are caused to stop their operations in proper response to the main body cover being opened, and even at the time of a counter electromotive force being generated by the drive motor 701, the image forming apparatus 1 will not make malfunctioning, the normal interlock function being allowed to be secured.

Further, in the aforementioned step S5, in the case where it has been determined that a rise of the interlock signal has been detected, after the aforementioned waiting time having elapsed (YES in S7), the control part 100 causes the switch mechanism 52 to connect between the motor unit 70 and the fan motor 90; therefore, whether the cause for the interlock signal having reached the aforementioned voltage value V1 is the switching circuit 58 having been brought into a closed state, or a counter electromotive force generated by the motor unit 70 can be identified, and only in the case where the counter electromotive force generated is the cause, it is possible to perform control of bringing the fan motor 90 into a drivable state.

By configuring the system as above, the following advantages can be effected.

Conventionally, in order to detect a counter electromotive force to cause the counter electromotive force to be consumed, it has been required to newly add a circuit for detecting the counter electromotive force. Alternatively, in order to cause the counter electromotive force to be consumed, it has been required to add such a component as a diode.

Contrarily to this, the technology of the present disclosure has been made in order to solve the aforementioned problem, allowing the counter electromotive force to be consumed with no need for adding a circuit for detecting a counter electromotive force or a component, and occurrence of a malfunction resulting from generation of a counter electromotive force to be minimized for securing the normal interlock function.

In other words, according to the present disclosure, even if the drive motor of the motor unit generates a counter electromotive force while the main body cover of the image forming apparatus is opened for jam clearing, the motor unit and the drive unit are brought into a connection state with the power from the power supply being cut off.

Therefore, the counter electromotive force can be consumed by the drive unit with no need for newly adding a circuit for detecting a counter electromotive force or a component. Further, thereby, the occurrence of a malfunction resulting from a counter electromotive force generated can be minimized for securing the normal interlock function.

Further, according to the present disclosure, in the case where the drive unit is the fan motor 90, a wind can be made at the time of a counter electromotive force being generated. Thereby, an advantage that dirt and dust, or the like, produced at the time of occurrence of a jam can be blown for ease of removal can be effected. Further, in the case where the drive unit is a polygon mirror, an advantage that a paper debris scrap which clogs the exposure part, being difficult to be removed, can be easily removed can also be effected.

The present disclosure is not limited to the configuration in the aforementioned embodiment, and allows various modifications. For example, the aforementioned embodiment has been explained using a multifunctional peripheral as one embodiment of an image forming apparatus according to the present disclosure, however, this is only an example, and the present disclosure is also applicable to other electronic equipment, for example, other image forming apparatuses, such as a printer, a copying machine, and a facsimile apparatus.

Further, the configuration and processings which have been described with the aforementioned embodiment using FIG. 1 to FIG. 5 are only one embodiment of the present disclosure, and are not intended to limit the present disclosure to those alone.

What is claimed is:

1. An image forming apparatus, comprising:
a motor unit for imparting a rotation driving force to respective rotating members for carrying a recording medium;
an interlock switching circuit provided in a power supply line for connecting a power supply to said motor unit to supply power thereto, connecting between said motor unit and said power supply upon a main body cover being closed, and disconnecting between said motor unit and said power supply upon the main body cover being opened;
a power cut-off detection part for detecting, on the basis of a voltage of said power supply line, whether or not supply of power from said power supply is cut off;
a drive unit being connected to said power supply and said motor unit by said power supply line, imparting a rotation driving force to a mechanism provided as a driven body, the mechanism being different from said respective rotating members;
a connection switching part for switching over to connection or disconnection between said motor unit and said drive unit; and
a control part, upon cut-off of supply of power from said power supply being detected by said power cut-off detection part, stopping driving of respective mechanisms provided, and causing said connection switching part to connect between said motor unit and said drive unit.

2. The image forming apparatus according to claim 1, wherein, in case of said power cut-off detection part having detected cut-off of supply of power from said power supply, said control part causes said connection switching part to connect between said motor unit and said drive unit if a predetermined time having elapsed since a point in time that said power cut-off detection part having detected rise in voltage of said power supply line after detecting of cut-off of supply of power.

3. The image forming apparatus according to claim 1, wherein said drive unit is a fan motor which is provided with a fan as said driven body.

4. The image forming apparatus according to claim 1, wherein said drive unit is a polygon mirror which is provided with a polygon mirror as said driven body.

5. The image forming apparatus according to claim 2, wherein said drive unit is a fan motor which is provided with a fan as said driven body.

6. The image forming apparatus according to claim 2, wherein said drive unit is a polygon mirror which is provided with a polygon mirror as said driven body.

7. An image forming method, comprising:
upon a main body cover being closed, connecting between a motor unit and a power supply, and upon the main body cover being opened, disconnecting between said motor unit and said power supply,
on the basis of a voltage of a power supply line for connecting a power supply to said motor unit to supply power thereto, detecting whether or not supply of power from said power supply is cut off;
upon cut-off of supply of power from said power supply having been detected, driving of respective mechanisms being stopped, and a connection switching part being caused to connect between said motor unit and a drive unit.
